(19) United States
(12) Patent Application Publication
(10) Pub. No.: US 2009/0235550 A1
(43) Pub. Date: Sep. 24, 2009

(54) Drying device with at least two drums

(76) Inventors: Anja Fluegge, Ludwigsburg (DE); Hans Fladt, Willstaett-Legelshurst (DE); Ruediger Fladt, Willstaett-Legelshurst (DE)

Correspondence Address: DREISS, FUHLENDORF, STEIMLE & BECKER, POSTFACH 10 37 62, D-70032 STUTTGART, DE

(21) Appl. No.: 12/382,445

(22) Filed: Mar. 17, 2009

(30) Foreign Application Priority Data
Mar. 20, 2008 (DE) 10 2008 015 130.0

(51) Int. Cl. D06F 58/02; F26B 25/00; D06F 58/04

(52) U.S. Cl. 34/127; 34/236; 34/140

(57) ABSTRACT

A drying apparatus and a method for operating a drying apparatus are presented by means of which a considerable increase in efficiency is possible.

This application claims Paris Convention priority of DE 10 2008 015 130.0 filed Mar. 20, 2008, the complete disclosure of which is hereby incorporated by reference.

### BACKGROUND OF THE INVENTION

Laundries and hotels naturally produce large quantities of washed laundry that has to be dried. In times of increasing energy prices, the energy efficiency of this drying process is becoming ever more important.

At the same time, space is a limited resource in commercially used buildings, so that drying apparatus must make the best possible use of space.

EP 0 395 685 B1 discloses a drying apparatus that works in batch operation. To minimize the energy requirement for drying, this apparatus guides the drying gas in a circuit and the moisture contained in the drying gas after the gas has flowed through the laundry to be dried is removed by means of a condensate separator.

The disadvantage of this drying apparatus is that a large part thereof must be cooled down and then warmed up again when the drying apparatus is loaded and unloaded. Moreover no laundry can be dried during the loading and unloading time. The energy-efficiency and performance are therefore not optimal.

DE 694 06 546 D2 discloses a drying apparatus that functions continuously. In this case, the material to be dried is fed to a drying zone on a belt conveyor. In the drying zone, the material to be dried is transferred from the first belt conveyor to a second belt conveyor that moves the material to be dried through the drying zone. The dried material is then transferred to a third belt conveyor and brought out of the drying zone. The disadvantages of this apparatus are that the mechanism is complicated and the space requirement large.

DE 583 260 discloses a drying apparatus in which the material to be dried is guided consecutively through different drying zones in different drums. Each drying zone has a separate housing, a dedicated fan, and a dedicated heat exchanger. The complicated structure results in high production costs and a large space requirement. Moreover, energy efficient operation of the drying apparatus is prevented or at least made more difficult.

The object of this invention is to provide a drying apparatus that is an advantageous further development of the prior art in terms of energy efficiency and space requirement and also provides many options to achieve process optimization.

### SUMMARY OF THE INVENTION

This object is inventively achieved by means of a drying apparatus of the above mentioned kind having the characteristics of the independent claim.

In an advantageous embodiment of the invention, the apparatus for conveying the material to be dried comprises at least two drums for holding the material to be dried and a turnstile, one arm being attached to the turnstile for each drum and the drums being attached to the arms in such a way that they can rotate.

The positioning of the drums in space by means of a turnstile is characterized by an especially simple and therefore also robust structure.

Alternatively, it is also possible to guide the drums through the drying compartment by means of a toothed gear rim or running wheel rim, a system of rails, and toothed belts or chains.

The inventive drums are used as conveying containers to convey the material to be dried from a loading station into a drying zone. Moreover, the drums are used for conveying the material to be dried inside the drying zone and for subsequent removal of the dried material from the drying zone into an unloading station.

By using drums as the conveying containers, loading and unloading the drums can be decoupled from the actual drying process, enabling continuous drying of the material to be dried and permitting a constant temperature in the drying zone. This considerably increases the efficiency of drying, and cooling and heating losses, which necessarily occur in batch operation, are eliminated.

Due to the circular movement by which the drums are conveyed from the loading station into the drying zone and into the unloading station by means of the inventive turnstile or toothed gear rim or running wheel rim, a very compact design of the inventive drying apparatus is possible. The loading station and the unloading station can be disposed vertically beneath the drying zone so that the inventive drying apparatus only requires a small floor area.

Rails, chains, or toothed belt drives usually require a greater design effort but provide more options for the trajectories on which the drums can be moved by the dryer.

Because multiple drums are provided in accordance with the invention, a drum located in the loading station can be loaded concurrently with drying and a drum located in the unloading station can be cooled and unloaded.

Because, for example, two drums can be located in the drying zone while one drum each is located in the loading station and in the unloading station, the loading and unloading times can be decoupled from the drying times. Moreover, it is possible to move the drums within the drying zone in such a way that, after a first partial drying operation, the drum can be moved into another region of the drying zone. This is especially advantageous if drying is to be performed in two phases. For example, this can be achieved by a counterflow of superheated steam or steam-air mixture, or microwave or other radiation heating can be provided as support for drying with superheated steam in individual regions.

If a turnstile is used to move the drums, an axis of rotation of the turnstile preferably extends essentially horizontally. This ensures that rotating the turnstile moves the drums in the direction of the vertical axis, so that the inventive configuration of a drying zone can especially easily be implemented above the loading station and unloading station.

An analogous case applies if, as in another advantageous embodiment, the axes of rotation of the drums extend essentially horizontally.

To simplify loading and unloading of the drums, the drums may comprise a lockable loading opening, in particular, on the outer surface.

The housing containing the drying zone is advantageously thermally insulated, to minimize the heat losses during the drying operation. Moreover, the housing is, at least in the region of the drying zone, gas- and steam-tight, so that the drying gas cannot escape in an uncontrolled fashion.

In a further advantageous embodiment of the invention, the housing comprises a loading station and/or unloading station in the lower half, wherein the drums can be conveyed by rotating the turnstile, or operating the alternatively provided conveying mechanisms, into the loading station and unloading station.

Of course, it is also conceivable that there may be a combined loading and unloading station. This applies, in particular, if the number of drums is comparatively small and the time intervals between operations of the conveying mechanism, for example, of the turnstile, and the drying duration are comparatively long. In this case, the dried material contained in the drum can be removed and new wet material to be dried can be filled into the drum in one and the same station without the drum having to be moved. This combined loading and unloading station could, for example, be advantageous in drying apparatus with a total of three drums, disposed offset by 120° on the arms of the turnstile.

In a further advantageous embodiment of the invention, a condensate pipe is provided to take away the moisture extracted from the material being dried, without interrupting operation.

The drying zone can be heated directly with superheated steam, radiation heaters, and/or microwaves. Alternatively or in addition, it is also possible to heat the drying zone indirectly by means of heat exchangers and/or various energy sources, such as electricity, gas, oil, heat carrying oil and/or steam. Of course, other sources of energy are conceivable and possible.

To be able to terminate drying at the right instant every time, that is, not too early and not too late, a further advantageous embodiment of the invention comprises one or more weighing devices to sense the weight of the material being dried in the drums. By comparing the initial weight on loading the drum with the material to be dried with the current weight, the mass of the moisture that has been removed from the material being dried by the drying operation can be determined in order to terminate drying based on this quantity.

In an advantageous embodiment of the invention, the drying apparatus has three or four drums.

In a further advantageous embodiment of the invention, the drums can be rotated by drives so that, for example, they can be rotated during the drying operation to achieve better heat or moisture transition between the material being dried and the superheated steam used for drying. This increases the efficiency of the drying operation and reduces the drying time.

The rotation drives can also advantageously be deployed in the loading station and unloading station, for example, to position the loading opening in such a way that the drum can be easily loaded in the loading station and, for example, through use of a belt conveyor. Analogous possibilities apply to the unloading station. There, for example, it may be desirable to rotate the drums so that the loading opening is at the lowest point of the drum. When this loading opening is opened, the drum can be emptied with the assistance of gravity and the material dried can fall into a tub or mesh basket placed below.

The drums located in the drying zone are removed by rotating the turnstile out of the drying zone, as soon as the material being dried located in this drum has reached a sufficient degree of drying. This degree of drying may, for example, be reached after a certain drying duration has elapsed or it is possible to measure the weight reduction of the material being dried located in the drying zone and to determine the residual moisture still in the material being dried by means of this weight reduction. As soon as the residual moisture has fallen below a defined limit value, the drum can be moved out of the drying zone.

Further advantages and advantageous embodiments of the invention can be derived from the following drawings, their description, and the claims. All characteristics disclosed in the drawings, their description, and the claims may be essential to the invention both individually and in any combination.

### BRIEF DESCRIPTION OF THE DRAWING

FIG. 1 shows a front view of an embodiment of an inventive drying apparatus;

FIG. 2 shows a perspective view of an embodiment of an inventive drying apparatus;

FIG. 3 shows a rear view of the embodiment according to FIGS. 1 and 2 and,

FIGS. 4 and 5 shows embodiments of inventive conveying mechanisms.

### DESCRIPTION OF THE PREFERRED EMBODIMENT

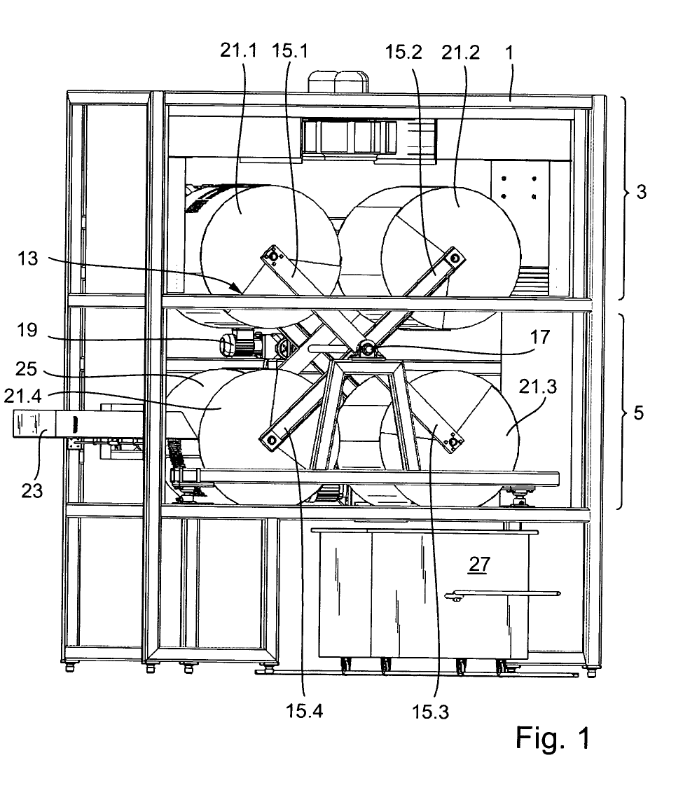

FIG. 1 shows an embodiment of an inventive drying apparatus partly cut open. A frame is visible. This frame is surrounded by thermally insulating boards on its sides and its upper part during normal operation to minimize heat exchange between the interior of the drying apparatus and the surroundings. The frames and boards constitute a housing 1 of the drying apparatus. In the vertical direction, the housing 1 can be divided into an upper part 3 and lower part 5. Between the upper part 3 and the lower part 5, there is a barrier in the form of a ceiling or intermediate floor. Separation of the upper part 3, which also contains a drying zone 7, and the lower part 5, which is divided into a loading station 9 and unloading station 11, is only necessary because of differences in temperature and humidity of the steam or steam/air mixture in the housing 1.

At the center of the housing 1, the turnstile 13 with a total of four arms 15.1 to 15.4 is disposed in such a fashion that it can rotate. An axis of rotation of the turnstile 13 and a rotation drive of the turnstile 13 are identified with reference symbols 17 and 19.

Each of the arms 15.1 to 15.4 has one drum 21.1 to 21.4. Drums 21.1 and 21.2 are located in the drying zone 7. These drums contain the material to be dried, in particular, laundry. The drums 21 are advantageously made of perforated stainless steel sheeting so that the laundry cannot fall out of the drums and to effect proper heat transition between the superheated steam and the material being dried located in the drying zone.

As soon as the material being dried that is located in drum 21.2 has reached the necessary residual moisture and is therefore sufficiently dry, the turnstile 13 is rotated 90° clockwise so that the drum 21.2 enters the unloading station 11. This also moves the drum 21.3 located in the unloading station into the loading station 9, where it can be loaded with wet laundry or wet material to be dried by means of a loading mechanism 23. At the same time, the already loaded drum 24.1 moves out of the loading station 9 into the drying zone 7.

Because two drums, i.e. drums 21.1 and 21.2, are located in the drying zone 7 at the same time, the drying time is twice as long as the loading and unloading time of the drums 21.4 and 21.3. As can be seen from FIG. 1, the drums 21 have the shape of a cylindrical hollow body. A loading opening 25 that can be locked is provided on the cylindrical part of the drums 21. In the case of the drum 21.4 located in the loading station 9, the loading opening 25 is opened and the drums 21.4 rotated in such a way that the drum 21.4 opens in the upward direction and can be loaded with laundry using a loading mechanism 23.

In the case of drums 21.1 and 21.2 located in the drying zone 7, the loading openings are closed so that no laundry can fall out of the drums 21, even if they are rotated about their own axis during the drying operation.

In the case of drum 21.3 located in the unloading station 11, the loading opening 25 is opened and faces downward. In this way, the dried laundry located in the drum 21.3 can fall into a conveying truck 27 with the aid of gravity and be conveyed away.

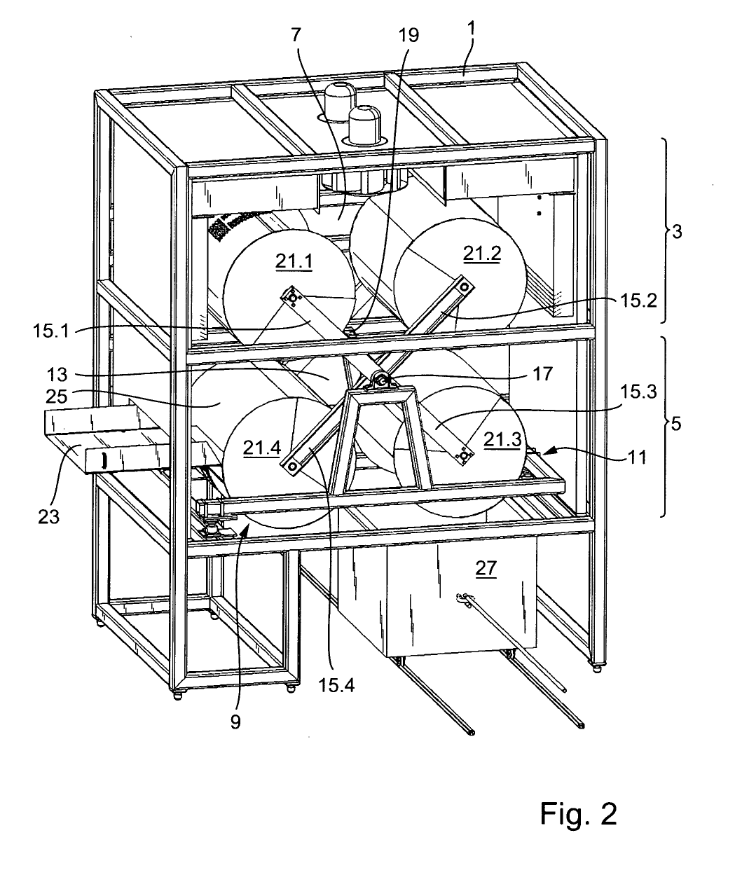

FIG. 2 shows the same embodiment in a perspective view. The same components are identified by the same reference symbols and the description of FIG. 1 applies accordingly.

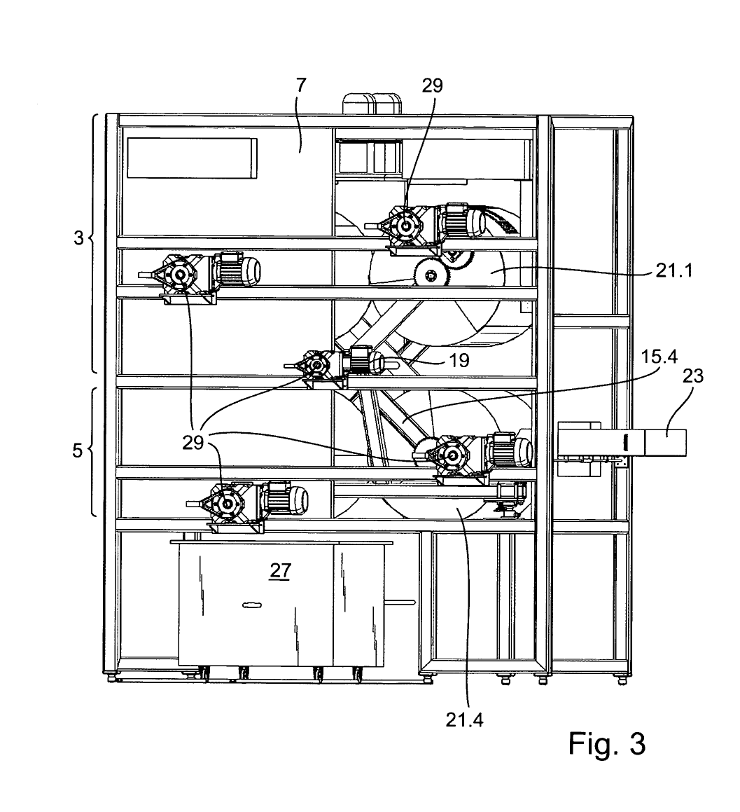

FIG. 3 shows the rear of the inventive drying apparatus. In this case, the left part of the drying apparatus is clad with sidewalls whereas the right part is shown cut open. As can be seen from FIG. 3, a total of five motors 29 are secured to the frame of the housing 1. The motor 29 located in the center is used to drive the turnstile 13, while the other motors 29 are used to drive their respective drums 21. The motors 29 are attached in a stationary manner and do not rotate with the turnstile.

The motors 29 allocated to the drums 21 could also be attached to the arms of the turnstile 13. However, in that case, the power supply for the motors and the positioning of the drums and the loading openings 25 of the drums in the loading station 9 and the unloading station 11 would be more difficult to implement.

In an embodiment of the inventive drying apparatus that is suitable for laundries and hotels, the heating power is approximately 160 kW and the cycle time 20 minutes. This means that the four drums are moved through 90° by their turnstile 23 every five minutes. The drum 21 is always located in the loading station 9, a further drum in the unloading station, and two drums 21 are located in the drying zone 7.

Cooling of the laundry is performed outside the machine. On exiting the drying zone, the drums 21 are naturally warm and then cool down. This noticeable loss of heat is unavoidable but very slight compared with other drying apparatus operated in batch operation.

The energy efficiency of the inventive drying apparatus is very good. Savings of 30 to 70% over conventional dryers can be expected.

The condensate obtained when drying the laundry can be further used in other processes because it already has a temperature of about 70 to 80° C., which is slightly below boiling point. The condensate is collected in the boundary region between the drying zone 3 and the lower area of 5. This is done by pumping cooling water through pipes. The moisture condenses on the surface of these pipes and drips into collection channels disposed beneath the pipes. These collection channels run into the condensate pipe. This configuration not only removes the condensate but also has the function of separating the drying zone 3 from the lower area 5.

Because the entire drying zone constantly remains at operating temperature, very high efficiency is achieved in this region, and the system leads to very high performance of the drying zone 7.

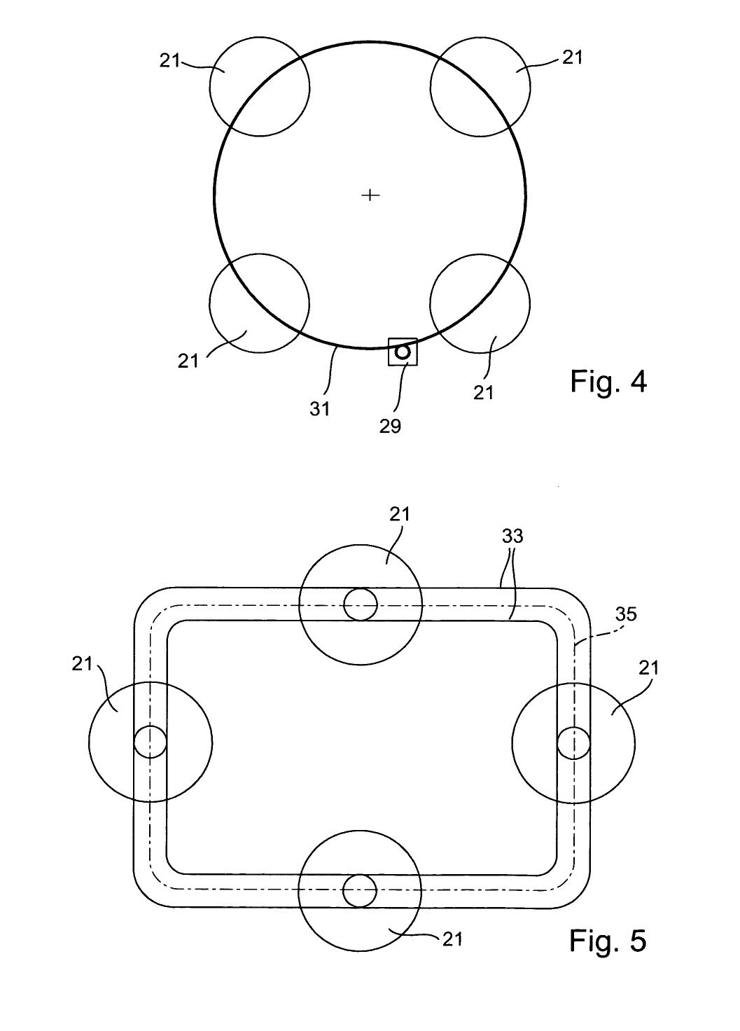

FIG. 4 shows a very simplified diagram of a special embodiment of a rotating mechanism for the drums 21. In this embodiment, the rotating apparatus is constituted as a toothed gear or running wheel 31. The toothed gear or running wheel 31 is constituted as a gear wheel with exterior toothing and is driven via a pinion (not shown) of a drive motor, in particular, of a motor 29, when required. In this embodiment, the required torque of the motor 29 is relatively small because of the large diameter of the disk wheel.

In this embodiment according to FIG. 5, the drums 21 are guided in guide rails 33 through a “rectangular” trajectory. For example, the drums are driven via a pull rope or chain 35 or via a toothed belt or pinion.

We claim:

1. A drying apparatus, the apparatus comprising:
a housing, said housing defining a heated drying zone disposed in an upper part of said housing, a loading station and/or an unloading station, wherein said loading station and/or said unloading station are disposed in a lower part of said housing;
at least two drums for holding material to be dried; and
a conveying mechanism to which said at least two drums are mounted such that they can rotate, said conveying mechanism conveying the material to be dried into and out of said heated drying zone, said loading station and/or said unloading station.

2. The drying apparatus of claim 1, wherein said conveying mechanism comprises a turnstile having one arm for each drum.

3. The drying apparatus of claim 2, wherein an axis of rotation of said turnstile extends essentially horizontally.

4. The drying apparatus of claim 1, wherein said conveying mechanism comprises at least one conveying wheel, a toothed gear and/or a running wheel to which said drums are attached such that they can rotate.

5. The drying apparatus of claim 4, wherein an axis of rotation of said conveying wheel, said toothed gear and/or said running wheel extends essentially horizontally.

6. The drying apparatus of claim 1, wherein said conveying mechanism comprises rails, chains, and/or toothed belts.

7. The drying apparatus of claim 1, wherein axes of rotation of said drums extend essentially horizontally.

8. The drying apparatus of claim 1, wherein said drums have a lockable loading opening.

9. The drying apparatus of claim 1, wherein said drums are surrounded by a thermally insulated housing that is gas-tight in said upper part.

10. The drying apparatus of claim 2, wherein said drums can be moved into said drying zone, said loading station and/or said unloading station by rotating said turnstile.

11. The drying apparatus of claim 1, further comprising a condensate pipe for removing condensate from said drying zone.

12. The drying apparatus of claim 1, wherein said drying zone is heated with superheated steam, radiation heaters and/or microwaves.

13. The drying apparatus of claim 1, further comprising one or more weighing devices cooperating with said drums to detect a weight of the material being dried which is located in said drums.

14. The drying apparatus of claim 1, the apparatus comprising four drums.

15. The drying apparatus of claim 1, wherein said drums are driven such that they rotate.

16. The drying apparatus of claim 15, wherein each of said drums has a loading opening which is positioned by rotation of said drums in such a way that said drums can be loaded by a stationary loading mechanism or a conveyor belt at said loading station.

17. The drying apparatus of claim 15, wherein a loading opening of said drums is positioned by rotation of said drums in such a way that said drums can be unloaded by a stationary unloading mechanism at said unloading station.
